(19) United States
(12) Patent Application Publication
(10) Pub. No.: US 2005/0088373 A1
(43) Pub. Date: Apr. 28, 2005

(54) Gray scale expression method in plasma display panel and driving apparatus for plasma display panel

(76) Inventor: Soo-Jin Lee, Suwon-si (KR)

Correspondence Address: MCGUIREWOODS, LLP, 1750 TYSONS BLVD, SUITE 1800, MCLEAN, VA, 22102, US

(21) Appl. No.: 10/968,170

(22) Filed: Oct. 20, 2004

(30) Foreign Application Priority Data
Oct. 23, 2003 (KR) 10-2003-0074228

(51) Int. Cl. G09G 3/28

(52) U.S. Cl. 345/60

(57) ABSTRACT

A gray scale expression method in a plasma display panel (PDP) and a driving apparatus for the PDP improves color coordinate adjustment. When the brightness coefficient of an input image signal is varied step by step in accordance with an external adjustment signal, a dithering algorithm is applied to the image signal to vary the gray scale of the image signal by 0.25 for every variation of the brightness coefficient. The dithering algorithm is applied to the pixels or frames of the input image signal such that the pixels or frames exhibit opposite characteristics in a time direction.

### CROSS REFERENCE TO RELATED APPLICATION

This application claims priority to and the benefit of Korean Patent Application No. 10-2003-0074228, filed on Oct. 23, 2003, which is hereby incorporated by reference for all purposes as if fully set forth herein.

### BACKGROUND OF THE INVENTION

1. Field of the Invention

The present invention relates to a method for expressing gray scales in a plasma display panel (PDP) and a driving apparatus for a PDP, and more particularly, to a method for expressing gray scales and a PDP with improved color coordinate adjustment.

2. Discussion of the Related Art

Recently, flat panel displays, such as liquid crystal displays (LCDs), field emission displays (FEDs) and PDPs, have been actively developed. The PDPs are advantageous over the other flat panel displays due to their high luminance, high luminous efficiency and wide viewing angle. Accordingly, they are being highlighted as a substitute for conventional cathode ray tubes (CRTs) for displays of more than 40 inches.

The PDPs use plasma generated by gas discharge to display characters or images, and they may include more than several tens of thousands to millions of pixels arranged in a matrix. These PDPs are classified into a direct current (DC) type or an alternating current (AC) type according to patterns of waveforms of driving voltages and discharge cell structures.

The DC PDP has electrodes exposed to a discharge space, thereby causing current to flow through the discharge space during application of a voltage, which requires a resistor for limiting the current. On the other hand, the AC PDP's electrodes are covered with a dielectric layer that naturally forms a capacitance component to limit the current and protects the electrodes from the impact of ions during a discharge. As a result, the AC PDP has a longer lifespan than the DC PDP.

FIG. 1 is a perspective view illustrating a part of an AC PDP.

Referring to FIG. 1, scan electrodes 4 and sustain electrodes 5, covered with a dielectric layer 2 and a protective layer 3, are arranged in pairs in parallel on a first glass substrate 1. A plurality of address electrodes 8, covered with an insulation layer 7, is arranged on a second glass substrate 6. Partition walls 9 are formed in parallel with the address electrodes 8 on the insulation layer 7 such that each partition wall 9 is interposed between adjacent address electrodes 8. A phosphor 13 is coated on the surface of the insulation layer 7 and on both sides of each partition wall 9. The first and second glass substrates 1 and 6 are sealed together and define a discharge space 11 therebetween, and the address electrodes 8 are orthogonal to the scan electrodes 4 and sustain electrodes 5. Intersections between each address electrode 8 and each pair of the scan electrodes 4 and sustain electrodes 5 form a discharge cell 12 in the discharge space 11.

Deviations in target color coordinates are used as a reference to determine whether PDP products are of high quality. In other words, whether a PDP product is of high quality may be based on a difference between target color coordinates to be displayed and actual color coordinates exhibited in the PDP. In order to satisfy the target color coordinates, brightness and contrast coefficient adjusters may be used.

FIG. 2 is a block diagram illustrating logics to adjust color coordinates in a conventional PDP. FIG. 3a and FIG. 3b show concepts of operation for the brightness coefficient adjuster and the contrast coefficient adjuster of FIG. 2.

As shown in FIG. 2, the conventional PDP may include a brightness coefficient adjuster 10, a gamma corrector 20, and a contrast coefficient adjuster 30.

The brightness coefficient adjuster 10 adjusts the level of an input image signal, using an offset concept, based on an external adjustment signal (a signal optionally applied for adjustment of color coordinates after the manufacture of the product). When the input gray scale of the input image signal is less than a predetermined offset value, the brightness coefficient adjuster 10 may adjust the gray scale to be not less than the predetermined offset value, as shown in FIG. 3a. For example, where the predetermined offset value is 3, the brightness coefficient adjuster 10 may adjust an input gray scale of 0, 1 or 2 such that the gray scale corresponds to 3.

The gamma corrector 20 maps n bits (typically, 8 bits) of the input image signal to an inverse gamma curve to correct the signal into an image signal having m bits (m≧n and m is typically 12 bits). The gamma corrector 20 may include both the panel gamma correcting function, which performs gamma correction in accordance with the characteristics of the panel, and the image gamma correcting function, which performs gamma correction in accordance with the characteristics of the input image.

The contrast coefficient adjuster 30 adjusts image signal data outputted from the gamma corrector 20, using a gain concept, based on an external adjustment signal (a signal optionally applied for adjustment of color coordinates after the manufacture of the product), as shown in FIG. 3b.

When an increment/decrement in brightness coefficient is carried out step by step in the color coordinate adjustment system of FIG. 2, the output level of the brightness coefficient adjuster 10 (the input level of the gamma corrector 20) is also incremented/decremented step by step. For example, when the brightness coefficient is incremented/decremented step by step when the level of the input image signal is 34, the output level of the brightness coefficient adjuster 10 may be varied to 34±1, 34±2, 34±3 . . . .

FIG. 4 shows a variation of the input and output of the gamma corrector 20 and of color coordinates depending on increments/decrements in brightness coefficient made step by step by the brightness coefficient adjuster 10. In FIG. 4, the color coordinates x and y are expressed in terms of 10⁻³. When increments/decrements in brightness coefficient are carried out step by step, as shown in FIG. 4, the output value of the gamma corrector 20 also varies step by step, thereby causing a variation in color coordinates. However, the variation in color coordinates at each step is made by a value ranging from 0.007 to 0.016, and the variation of greater than 0.010 is generated, as shown in FIG. 4. Consequently, satisfactory color coordinate adjustment may not be achieved. In other words, an inability to finely adjust the color coordinates of manufactured PDPs may result in increased numbers of poor quality PDPs.

### SUMMARY OF THE INVENTION

The present invention provides a method for expressing gray scales in a PDP, and a driving apparatus for the PDP, with an improved ability to finely adjust color coordinates.

Additional features of the invention will be set forth in the description which follows, and in part will be apparent from the description, or may be learned by practice of the invention.

The present invention discloses a gray scale expression method in a plasma display panel (PDP) for displaying pictures on the PDP by dividing image frames into a plurality of sub-fields, and combining the sub-fields to display a gray scale. The method comprises applying a dithering algorithm to the gray scale of an image signal when a brightness coefficient of the image signal is varied step by step in accordance with a first external adjustment signal, and gamma-correcting the gray scale of the image signal. An error diffusion is performed for a plurality of pixels using lower-order bits of data of the gamma-corrected image signal.

The present invention also discloses an apparatus for driving a plasma display panel (PDP) to display pictures on the PDP by dividing image frames into a plurality of sub-fields and combining the sub-fields to display a gray scale. The apparatus comprises a brightness coefficient adjuster that varies a brightness coefficient of an image signal step by step in accordance with a first external adjustment signal, and a dithering unit to apply a dithering algorithm to an output of the brightness coefficient adjuster when the brightness coefficient is varied. A gamma corrector gamma-corrects the gray scale of the image signal outputted by the dithering unit, and an error diffuser performs an error diffusion for a plurality of pixels using lower-order bits of data of the image signal gamma corrected by the gamma-corrector as errors.

The present invention also discloses a method for expressing gray scale in a plasma display panel, comprising applying a dithering algorithm to the gray scale of an image signal when a brightness coefficient of the image signal is varied step by step in accordance with an external adjustment signal.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a perspective view illustrating a part of a general AC PDP.

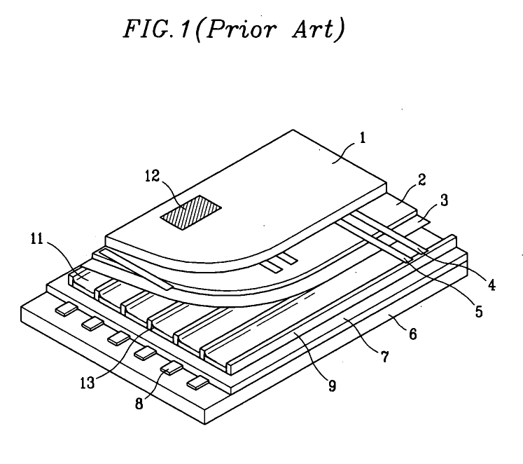

FIG. 2 is a block diagram illustrating a conventional apparatus for adjusting color coordinates.

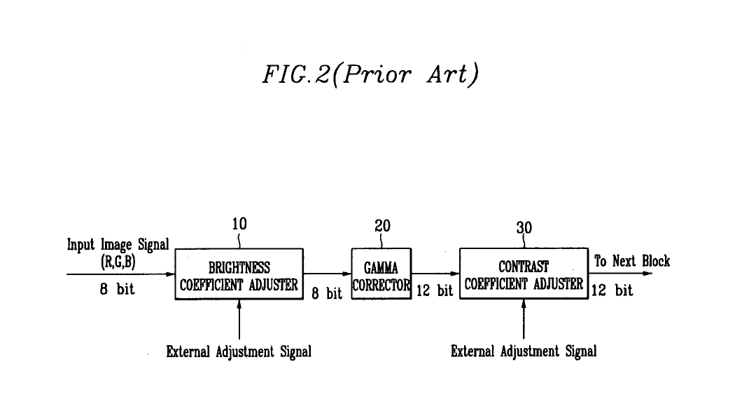

FIG. 3a shows the concept of a brightness coefficient adjustment, and FIG. 3b shows the concept of a contrast coefficient adjustment.

FIG. 4 shows a variation in the output data of a gamma corrector and a variation in color coordinates depending on changes in brightness coefficient made step by step by a conventional brightness coefficient adjuster.

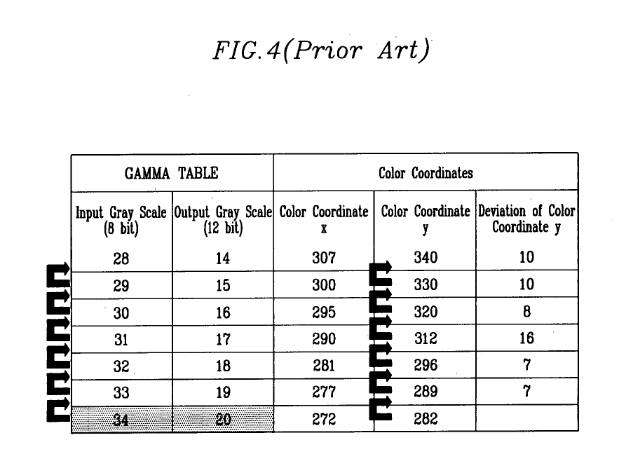

FIG. 5 is a block diagram illustrating a driving apparatus for a PDP that can finely adjust the color coordinates in the PDP in accordance with an exemplary embodiment of the present invention.

FIG. 6a shows an example wherein a 2×2 spatial algorithm is applied when the brightness coefficient of an input image signal is varied step by step in a brightness coefficient adjuster in accordance with an external adjustment signal, and FIG. 6b shows the output level of a gamma corrector after applying a dithering algorithm.

FIG. 7 shows a color coordinate deviation generated by the apparatus of FIG. 5.

### DETAILED DESCRIPTION

In the following detailed description, exemplary embodiments of the present invention are shown and described, by way of illustration. As those skilled in the art would recognize, the described exemplary embodiments may be modified in various ways, all without departing from the spirit or scope of the present invention. Accordingly, the drawings and description are to be regarded as illustrative in nature, rather than restrictive.

In the drawings, illustrations of elements having no relation with the present invention are omitted in order to more clearly present the subject matter of the present invention. In the specification, the same or similar elements are denoted by the same reference numerals even though they are depicted in different drawings.

Exemplary embodiments of the present invention will now be described in detail with reference to the annexed drawings.

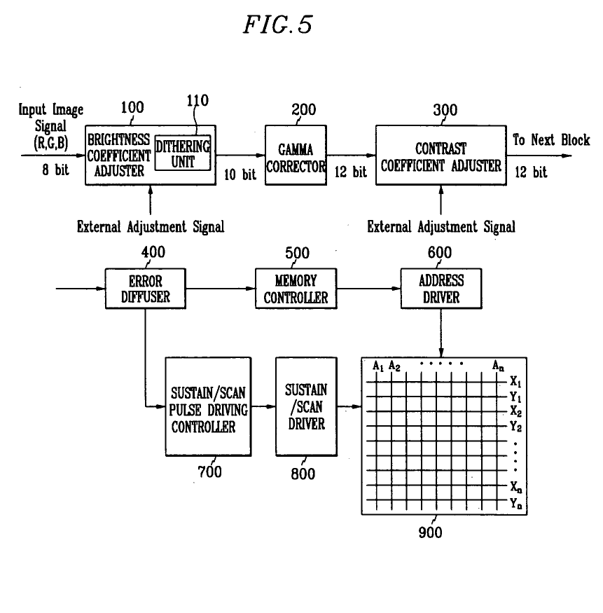

FIG. 5 is a block diagram illustrating a driving apparatus for a PDP that can finely adjust the color coordinates in the PDP in accordance with an exemplary embodiment of the present invention.

As shown in FIG. 5, the driving apparatus may include a brightness coefficient adjuster 100, a gamma corrector 200, a contrast coefficient adjuster 300, an error diffuser 400, a memory controller 500, an address driver 600, a sustain/scan pulse driving controller 700, and a sustain/scan pulse driver 800. The brightness coefficient adjuster 100 includes a dithering unit 110. Alternatively, the dithering unit 110 may be separately arranged between the brightness coefficient adjuster 100 and the gamma corrector 200. In this case, the number of image signal bits outputted from the dithering unit 110 may be greater than the number of bits inputted into it.

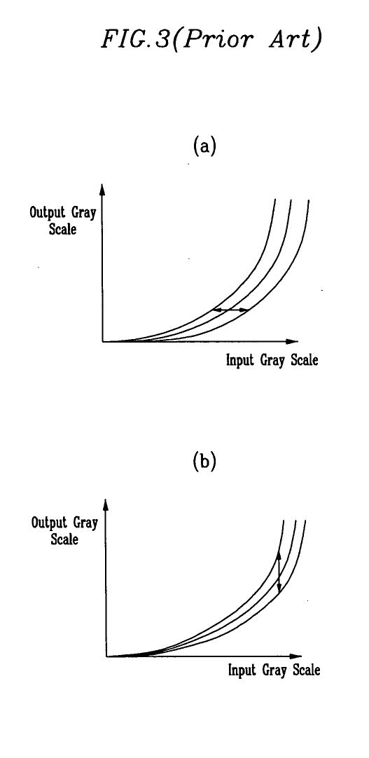

The brightness coefficient adjuster 100 adjusts a level of an input image signal, using an offset concept, based on an external adjustment signal (a signal optionally applied for adjustment of color coordinates after the manufacture of the product). When the input gray scale of the input image signal is less than a predetermined offset value, the brightness coefficient adjuster 100 may adjust the gray scale to be not less than the predetermined offset value, as shown in FIG. 3a.

Here, “brightness adjustment” may be carried out to set the zero level of image signals to be equivalent to black on a screen, and is mainly used to adjust an output level of a low gray scale. In other words, equivalent black/white may not be expressed when the panel exhibits a low light emission rate for a particular image signal or has color coordinates not meeting a desired specification, even after adjusting the brightness and color coordinates using a brightness adjustment pattern displayed on the screen. In this case, the brightness coefficient of the input image signal may be adjusted to express an equivalent white in order to satisfy the brightness and color coordinates of the panel.

When an external adjustment signal is applied to adjust the brightness coefficient by one step, the brightness coefficient adjuster 100 uses a dithering algorithm (executed by the dithering unit 110) to enhance gray scale expression capability. Specifically, the brightness coefficient may be varied one step in accordance with the external adjustment signal, thereby varying the output level of the brightness coefficient adjuster 100 by a value of 0.25, using a 2×2 spatial dithering algorithm. The dithering algorithm is executed by the dithering unit 110, which may be included in the brightness coefficient adjuster 100. Alternatively, as described above, the dithering unit 110 may be separately arranged between the brightness coefficient adjuster 100 and the gamma corrector 200. Applying the output value of the brightness coefficient adjuster 100 to the dithering algorithm may enhance gray scale expression capability.

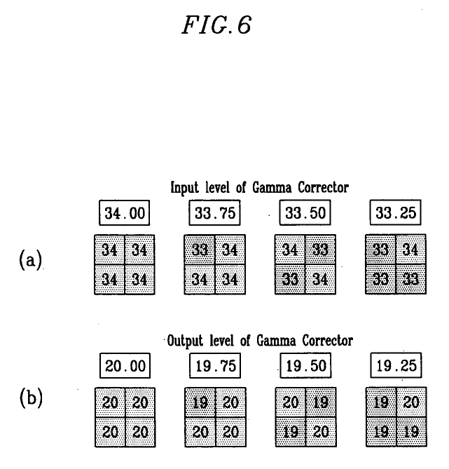

FIG. 6a shows an example wherein the 2×2 spatial algorithm is applied when the brightness coefficient adjuster 100 varies the brightness coefficient of an input image signal, having a level of 34, step by step in accordance with an external adjustment signal. As shown in FIG. 6a, when the brightness coefficient of the input image signal is varied one step from the level of 34, 2×2 pixels, to which the 2×2 spatial dithering algorithm is applied, have brightness coefficients of 33, 34, 34, and 34, in the order of rows. In this case, accordingly, the gamma corrector 200 has an input level of 33.75. When the brightness coefficient of the input image signal is varied two steps, the pixels have brightness coefficients of 34, 33, 33, and 34, in the order of rows, in accordance with application of the dithering algorithm. In this case, the gamma corrector 200 has an input level of 33.50. When the brightness coefficient of the input image signal is varied three steps, the pixels have brightness coefficients of 33, 34, 33, and 33, in the order of rows, in accordance with application of the dithering algorithm. In this case, the gamma corrector 200 has an input level of 33.25. Thus, the input level of the gamma corrector 200 is varied by 0.25 every time the brightness coefficient varies one step. As a result, the brightness coefficient adjuster 100 converts an 8-bit input signal into a 10-bit output signal in accordance with application of the dithering algorithm.

Although the dithering unit 110 of the brightness coefficient adjuster 100 has been described with reference to a 2×2 spatial algorithm, an N×N spatial algorithm may be applied. In this case, the N×N spatial algorithm may convert the input level of the gamma corrector 200 to a considerably low level, as compared to the 2×2 spatial algorithm. Accordingly, it may be possible to achieve a finer color coordinate adjustment.

Also, the dithering algorithm shown in FIG. 6a may be applied in a different manner for every frame to circulate the levels of the pixels with the lapse of time so that the levels of the pixels exhibit 33, 34, 34, and 34 in the order of rows in a vertical sync frame (1V), and 34, 33, 34, and 34 in the order of rows in a next vertical sync frame (2V), so as to prevent formation of a regular pattern.

FIG. 6b shows the output level of the gamma corrector 200 when the dithering algorithm is applied. Referring to FIG. 6b, the output level of the gamma corrector 200 is varied by a value of 0.25 every time the brightness coefficient is varied one step in accordance with an external adjustment signal.

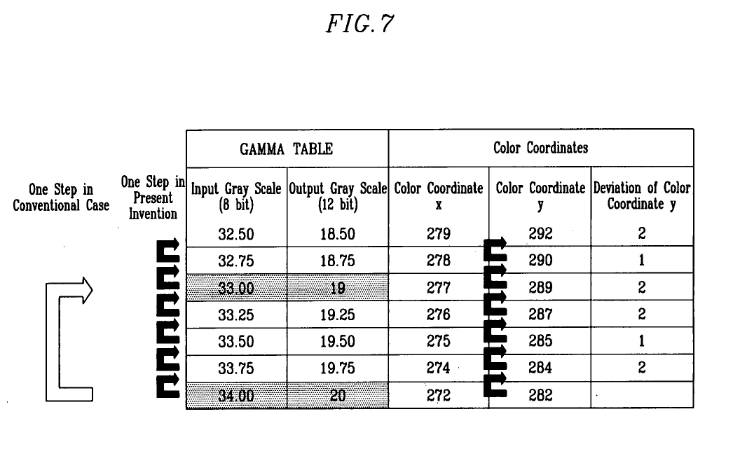

FIG. 7 shows a color coordinate deviation generated every time the brightness coefficient is varied one step in the brightness coefficient adjuster 100 in accordance with an external adjustment signal. The color coefficients x and y are expressed in terms of 10⁻³.

As shown in FIG. 7, the input level of the gamma corrector 200 may be reduced by a value of 0.25 every time the brightness coefficient of the brightness coefficient adjuster 100 is reduced one step. As a result, the output level of the gamma corrector 200 may also be reduced by a value of 0.25 in accordance with every reduction of the input level. FIG. 7 shows that a color coordinate deviation of not more than ±0.002 is exhibited through the brightness coefficient adjustment.

When the brightness coefficient adjuster 100 varies the brightness coefficient, step by step, utilizing the dithering algorithm as discussed above, it is possible to satisfactorily reduce the color coordinate deviation of not more than 0.002. Hence, the rate of poor-quality products, caused by an inability to adjust their color coordinates, may be reduced, and the capability to express colors of low gray scales may be enhanced.

Again referring to FIG. 5, the gamma corrector 200 gamma-corrects the input level (gray scale) thereof varied by a value of 0.25 in accordance with every increment/decrement of the brightness coefficient by the brightness coefficient adjuster 100, thereby converting the 10-bit image signal into a 12-bit image signal. In this case, the gamma corrector 200 includes both the panel gamma correcting function, which performs gamma correction in accordance with the characteristics of the panel, and the image gamma correcting function, which performs gamma correction in accordance with the characteristics of the input image. When the input level of the gamma corrector 200 varies 0.25 by 0.25, the output level (gray scale) of the gamma corrector 200 also varies 0.25 by 0.25. However, the output level (gray scale) of the gamma corrector 200 corresponds to a 12-bit image signal.

The contrast coefficient adjuster 300 adjusts a level of image signal data outputted from the gamma corrector 200, using a gain concept, based on an external adjustment signal (a signal optionally applied for adjustment of color coordinates after the manufacture of the product), thereby performing a contrast coefficient adjustment. In other words, the contrast coefficient adjuster 300 adjusts the level of the image signal data, as shown in FIG. 3b.

Here, “contrast adjustment” is used to amplify the input image signal or to set light outputted from the monitor screen to a comfortable level, after completion of the brightness adjustment, and it is also used to adjust the ratio between the low and high gray scales in the output signal. Equivalent black/white may not be expressed when the panel exhibits a low light emission rate for a particular image signal or has color coordinates not meeting a desired specification, even after adjusting the brightness and color coordinates using a brightness adjustment pattern displayed on the screen. In this case, the contrast coefficient of the input image signal is adjusted such that equivalent white may be expressed, so as to satisfy the brightness and color coordinates of the panel. This contrast adjustment is mainly used to adjust brightness and color coordinates for high gray scales.

The error diffuser 400 receives image signal data outputted from the contrast coefficient adjuster 300, and applies error diffusion to the image signal data by diffusing the lower-order bits of the image signal data to peripheral pixels, in order to improve the capability to express low gray scales.

The memory controller 500 generates sub-field data corresponding to RGB image data outputted from the error diffuser 400.

The address driver 600 generates address data corresponding to the sub-field data outputted from the memory controller 500, and applies the address data to the address electrodes A₁, A₂, . . . , Aₘ of the PDP 900.

The sustain/scan pulse driving controller 700 generates a sub-field arrangement corresponding to the RGB image data outputted from the error diffuser 400, generates a control signal based on the sub-field arrangement, and outputs the control signal to the sustain/scan pulse driver 800.

The sustain/scan pulse driver 800 generates sustain pulses and scan pulses, based on the sub-field arrangement outputted from the sustain/scan pulse driving controller 700, and applies the sustain pulses and scan pulses to the sustain electrodes X₁, X₂, . . . , Xₙ and the scan electrodes Y₁, Y₂, . . . , Yₙ of the PDP 900, respectively.

As is apparent from the above description, where a variation in brightness coefficient is carried out step by step, a dithering algorithm is applied in accordance with the present invention to vary the input level of a gamma corrector to a considerably low level. Accordingly, it may be possible to more finely adjust color coordinates, thereby enhancing the capability to express low gray scales.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

1. A method for expressing gray scales in a plasma display panel (PDP) for displaying pictures on the PDP by dividing image frames into a plurality of sub-fields, and combining the sub-fields to display a gray scale, comprising:
applying a dithering algorithm to the gray scale of an image signal when a brightness coefficient of the image signal varies step by step in accordance with a first external adjustment signal;
gamma-correcting the gray scale of the image signal; and
performing an error diffusion for a plurality of pixels using lower-order bits of the gamma-corrected image signal data.

2. The method of claim 1, wherein the dithering algorithm is an N×N spatial dithering algorithm.

3. The method of claim 1,
wherein the dithering algorithm is a 2×2 spatial dithering algorithm; and
wherein the gray scale is varied by 0.25 every time the brightness coefficient varies one step.

4. The method of claim 2,
wherein the dithering algorithm is a 2×2 spatial dithering algorithm; and
wherein the gray scale is varied by 0.25 every time the brightness coefficient varies one step.

5. The method of claim 1,
wherein the dithering algorithm applies different values to successive image frames.

6. The method of claim 2,
wherein the dithering algorithm applies different values to the successive image frames.

7. The method of claim 1, further comprising:
adjusting a gain of the gray scale of the gamma-corrected image signal in accordance with a second external adjustment signal.

8. An apparatus for driving a plasma display panel (PDP) to display pictures on the PDP by dividing image frames into a plurality of sub-fields and combining the sub-fields to display a gray scale, comprising:
a brightness coefficient adjuster to vary a brightness coefficient of an image signal step by step in accordance with a first external adjustment signal;
a dithering unit to apply a dithering algorithm to an output of the brightness coefficient adjuster when the brightness coefficient varies;
a gamma corrector to gamma-correct the gray scale of the image signal outputted by the dithering unit; and
an error diffuser to perform an error diffusion for a plurality of pixels using lower-order bits of data of the image signal gamma-corrected by the gamma corrector as errors.

9. The apparatus of claim 8, further comprising:
a contrast coefficient adjuster to adjust a gain of the gray scale of the image signal, outputted by the gamma corrector, in accordance with a second external adjustment signal.

10. The apparatus of claim 8, wherein the dithering algorithm is an N×N spatial dithering algorithm.

11. The apparatus of claim 9, wherein the dithering algorithm is an N×N spatial dithering algorithm.

12. The apparatus of claim 10,
wherein the dithering algorithm is a 2×2 spatial dithering algorithm, and
wherein the gray scale is varied by 0.25 every time the brightness coefficient varies one step.

13. The apparatus of claim 10,
wherein the dithering algorithm applies different values to the successive image frames.

14. The apparatus of claim 8, wherein the brightness coefficient adjuster includes the dithering unit.

15. The apparatus of claim 14, wherein the image signal outputted from the brightness coefficient adjuster has more bits than the image signal inputted to the brightness coefficient adjuster.

16. The apparatus of claim 8, wherein the dithering unit is separately arranged between the brightness coefficient adjuster and the gamma corrector.

17. The apparatus of claim 16, wherein the image signal outputted from the dithering unit has more bits than the image signal inputted to the dithering unit.

18. A method for expressing gray scale in a plasma display panel, comprising:
applying a dithering algorithm to the gray scale of an image signal when a brightness coefficient of the image signal is varied step by step in accordance with an external adjustment signal.

19. The method of claim 18, wherein the dithering algorithm is an N×N spatial dithering algorithm.

20. The method of claim 19,
wherein the dithering algorithm is a 2×2 spatial dithering algorithm; and
wherein the gray scale is varied by 0.25 every time the brightness coefficient varies one step.
